(19) United States
(12) Patent Application Publication
(10) Pub. No.: US 2023/0178309 A1
(43) Pub. Date: Jun. 8, 2023

(54) COMPOISITE RUBBER DOME AND MOLDING METHOD

(71) Applicant: INJECTION PRECISION RUBBER (SUZHOU) CO.,LTD., Su Zhou (CN)

(72) Inventors: Zhihua Ding, Suzhou (CN); Peiyun Zhang, Su Zhou (CN)

(73) Assignee: INJECTION PRECISION RUBBER (SUZHOU) CO.,LTD., Su Zhou (CN)

(21) Appl. No.: 18/082,597

(22) Filed: Dec. 16, 2022

(51) Int. Cl. H01H 13/04; H01H 13/14

(52) U.S. Cl. CPC H01H 13/04; H01H 13/14

(57) ABSTRACT

The present disclosure discloses a composite rubber dome including a supporting part, an elastic connecting part, and a pressing part which are integrally molded with a silicon rubber material, wherein the pressing part is further provided with a composite part compositely molded with a rubber dome body by adopting an embedding or injection molding method and made of a non-silicon rubber material having higher hardness than the silicon rubber material, and the composite part and the pressing part are coaxially and correspondingly disposed in a pressing direction and the composite part is disposed on a side, in contact with a keycap, of an axial outer end of the pressing part, or a side, corresponding to a thin film circuit layer, of an axial inner end of the pressing part.

### FIELD

The present disclosure relates to the technical field of keyboards, in particular to a composite rubber dome and a molding method.

### BACKGROUND

A thin film keyboard mainly includes keycaps, scissored feet (X-shaped supports) arranged below the keycaps, and rubber domes, wherein the X-shaped supports are used to fix and stabilize the keycaps and are matched with a thin film circuit layer (i.e. a flexible circuit board) disposed on the bottom. With reference to FIG. 1, each of the rubber domes is shaped like an inverted bowl and mainly includes a supporting part 11, an elastic connecting part 12, and a pressing part 13, wherein the supporting part 11 on the rim of the bowl is mounted on the thin film circuit layer to support, and the pressing part 13 on the bottom of the bowl is used to be in contact with the keycap. When each of the keycaps is pressed, firstly, an axial outer end of the pressing part S3 of each of the rubber domes is in contact with the keycap first and is driven by the keycap to be triggered downwards, then, an axial inner end of the pressing part 13 applies a pressure to the inner thin film circuit layer to drive electrode contact points in the thin film circuit layer to be in contact with each other so as to achieve conduction, and after the pressing is canceled, the elastic connecting part 12 of the rubber dome enables the pressing part 13 to reset and drives the keycap to reset.

Since the rubber dome in the prior art is molded by integral injection of a silicon rubber material, with reference to FIG. 2, the rubber dome is smaller in return force during use, which affects the Click action tactile sense and the service life of the key and shortens the difference of P2 to P4, and thus, the pressing performance is nonideal.

### SUMMARY

In order to solve the above-mentioned technical problems, the present disclosure provides a composite rubber dome including a supporting part, an elastic connecting part, a pressing part and an exhaust ditch arranged on the supporting part and connected inside and outside, wherein the pressing part is further compounded with a composite part made of a non-silicon rubber material having higher hardness than the silicon rubber material, and the composite part and the pressing part are coaxially and correspondingly disposed in a pressing direction.

The composite part is disposed on a side, in contact with a keycap, of an axial outer end of the pressing part; or the composite part is disposed on a side, corresponding to the thin film circuit layer, of an axial inner end of the pressing part.

The present disclosure further provides a molding method for the above-mentioned composite rubber dome. When the rubber dome is molded by integral injection, the composite part is compositely molded with a rubber dome body by adopting an embedding or injection molding method.

According to the above-mentioned technical solutions, the composite part made of the non-silicon rubber material having higher hardness than the silicon rubber material is compounded on a side, in contact with the keycap or corresponding to the shaft core, of the pressing part of the rubber dome; and due to the existence of the composite part, a return force of the pressing part is more excellent, so that the Click action tactile sense of the key is improved and the service life of the key is effectively prolonged.

### BRIEF DESCRIPTION OF THE DRAWINGS

In order to describe the technical solutions in the embodiments of the present disclosure or the prior art more clearly, the accompanying drawings required for describing the embodiments or the prior art will be briefly introduced below.

FIG. 1 is a schematic view showing an axial sectional structure of a rubber dome in the prior art;

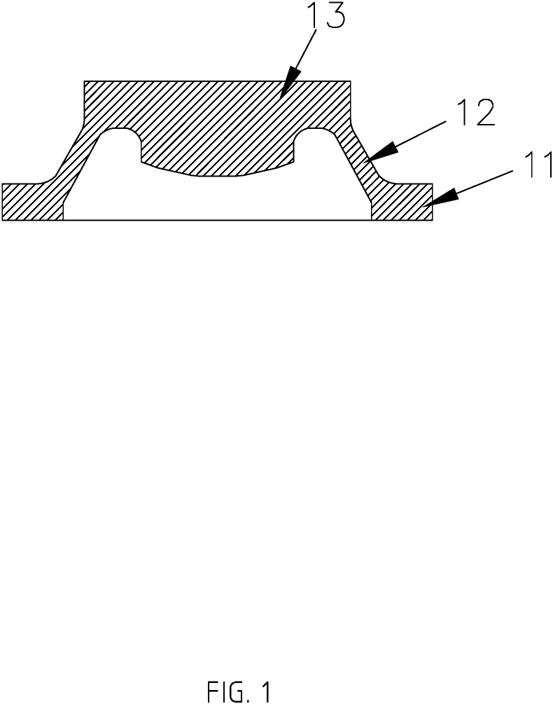

FIG. 2 is a schematic view showing the correspondence between a pressing force and a stroke of the rubber dome having the structure as shown in FIG. 1;

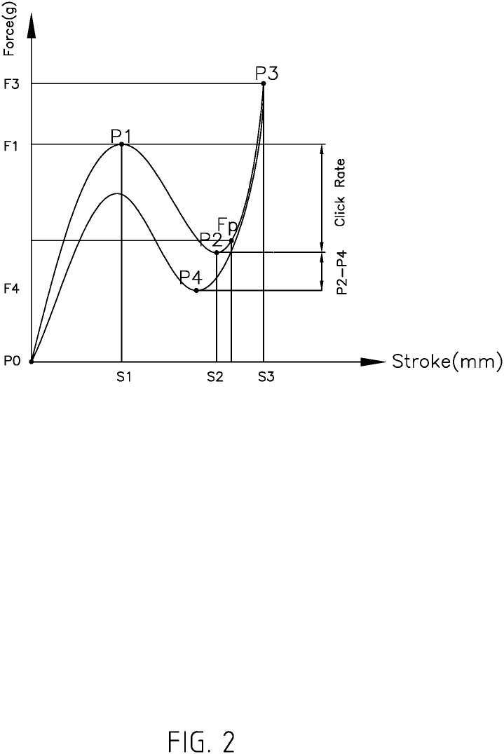

FIG. 3 is a schematic view showing an axial sectional structure of a rubber dome having a structure disclosed in the present disclosure;

FIG. 4 is a schematic view showing a top-view structure in FIG. 3;

FIG. 5 is a schematic view showing an axial sectional structure of a rubber dome having another structure disclosed in the present disclosure; and

FIG. 6 is a schematic view showing an axial sectional structure of a rubber dome having yet another structure disclosed in the present disclosure.

In the drawings: 11, supporting part; 12, elastic connecting part; 13, pressing part; 14, exhaust ditch; and 15, composite part.

### DETAILED DESCRIPTION OF THE EMBODIMENTS

The technical solutions in the embodiments of the present disclosure will be clearly and completely described below with conjunction with the accompanying drawings in the embodiments of the present disclosure.

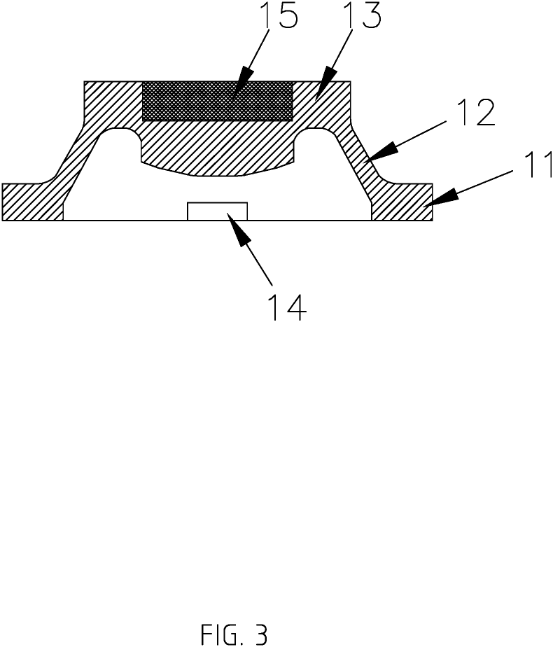

With reference to FIG. 3 to FIG. 6, the present disclosure provides a composite rubber dome including a supporting part 11, an elastic connecting part 12, a pressing part 13 and an exhaust ditch 14 arranged on an axial outer end of the supporting part 11 and connected inside and outside, wherein the pressing part 13 is further provided with a composite part 15 made of a non-silicon rubber material having higher hardness than the silicon rubber material, and the composite part 15 and the pressing part 13 are coaxially and correspondingly disposed in a pressing direction.

### Embodiment 1

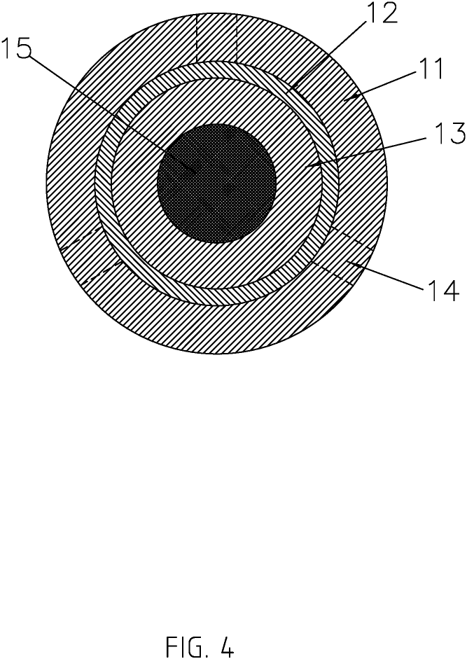

Specifically, the composite part 15 is disposed on an end, in contact with the keycap, of the axial outer end of the pressing part 13, and is compounded with the pressing part 13 in an embedding way as shown in FIG. 3 and FIG. 4;

### Embodiment 2

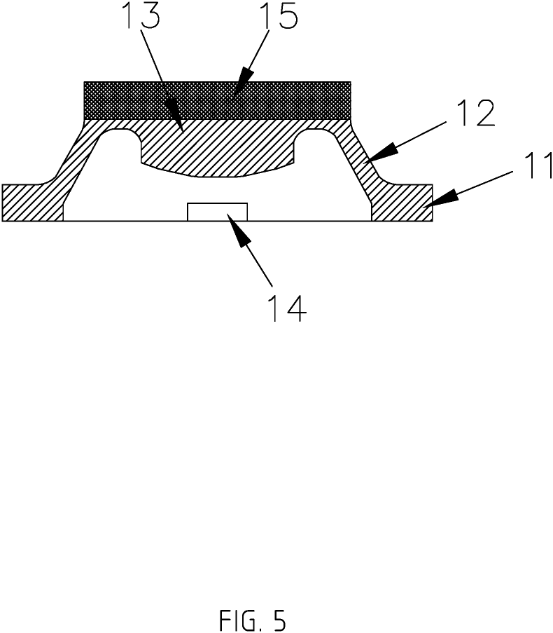

Specifically, the composite part 15 is disposed on an end, in contact with the keycap, of the axial outer end of the pressing part 13, and is compounded with the pressing part 13 in an equiradial cross-section fitting way as shown in FIG. 5.

### Embodiment 3

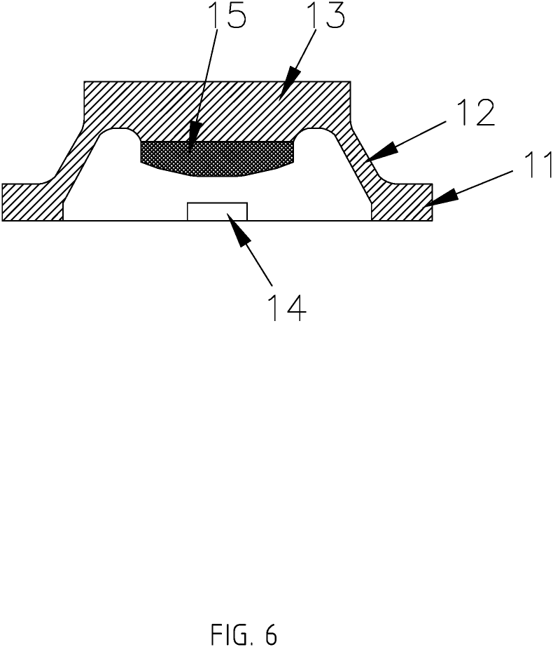

Specifically, as shown in FIG. 6, the composite part 15 is disposed on an end, corresponding to the thin film circuit layer, of the axial inner end of the pressing part 13.

### Embodiment 4

Based on the above embodiments 1-3, when the rubber dome is molded by integral injection, the composite part 15 is compositely molded with a rubber dome body by adopting an embedding method. For the embedding method, generally, the composite part 15 made of the hard non-silicon rubber material is directly embedded into a mold before being molded by injection, and next, the rubber dome body is molded by integral injection, and then is compositely molded with the composite part 15.

### Embodiment 5

Based on the above embodiments 1-3, when the rubber dome is molded by integral injection, the composite part 15 is compositely molded with a rubber dome body by adopting an injection molding method. For the injection molding method, generally, after the rubber dome body is molded by integral injection, and then, the composite part 15 is compositely molded by injection based on the molded rubber dome body.

According to the present disclosure, the composite part 15 made of the non-silicon rubber material having higher hardness than the silicon rubber material is compounded on a side, in contact with the keycap, of the axial outer end of the pressing part of the rubber dome, or a side, corresponding to the thin film circuit layer, of the axial inner end of the pressing part of the rubber dome; and due to the existence of the composite part 15 having the higher hardness than the silicon rubber material, an inward deformation pressure of the pressing part 13 is increased when the pressing part 13 is pressed downwards to elastically deform, so that a return force of the pressing part 13 is more excellent, and then, the Click action tactile sense of the key is improved and the service life of the key is effectively prolonged.

For the above-mentioned description for the embodiments of the present disclosure, the present disclosure can be implemented or used by the skilled in the art. Various modifications for the above-mentioned embodiments will become apparent to the skilled in the art, and the general principle defined herein can be implemented in other embodiments without departing from the spirit or scope of the present disclosure. Therefore, the present disclosure will not be limited to these embodiments described herein, but should conform to the widest scope consistent to the principle and novel characteristics disclosed herein.

What is claimed is:

1. A composite rubber dome, comprising a supporting part (11), an elastic connecting part (12), and a pressing part (13) which are integrally molded with a silicon rubber material, wherein the pressing part (13) is further provided with a composite part (15) made of a non-silicon rubber material having higher hardness than the silicon rubber material, and the composite part (15) and the pressing part (13) are coaxially and correspondingly disposed in a pressing direction.

2. The composite rubber dome of claim 1, wherein the composite part (15) is disposed on a side, in contact with a keycap, of an axial outer end of the pressing part (13).

3. The composite rubber dome of claim 1, wherein the composite part (15) is disposed on a side, corresponding to a thin film circuit layer, of an axial inner end of the pressing part (13).

4. The composite rubber dome of claim 1, wherein the supporting part (11) is also provided with an exhaust ditch (14) connected inside and outside.

5. A molding method for the composite rubber dome of claim 1, wherein when the rubber dome is molded by integral injection, the composite part (15) is compositely molded with a rubber dome body by adopting an embedding method.

6. A molding method for the composite rubber dome of claim 1, wherein when the rubber dome is molded by integral injection, the composite part (15) is compositely molded with a rubber dome body by adopting an injection molding method.
